(19) United States
(12) Patent Application Publication
(10) Pub. No.: US 2008/0183326 A1
(43) Pub. Date: Jul. 31, 2008

(54) Automatic A-Frame Picking System

(76) Inventor: Darin L. Danelski, Oconomowoc, WI (US)

Correspondence Address: REINHART BOERNER VAN DEUREN P.C., 2215 PERRYGREEN WAY, ROCKFORD, IL, 61107, US

(21) Appl. No.: 11/627,790

(22) Filed: Jan. 26, 2007

(51) Int. Cl. G06F 7/00; G06F 17/00

(52) U.S. Cl. 700/215; 700/216; 700/241

(57) ABSTRACT

An automated picking system is disclosed for filling orders of items. The A-frame picking system includes a central computer and a plurality of frames and their controllers, each frame including a plurality of items in dispensers with approximately vertical stacks. Each frame preferably also has a conveyor for transporting items dispensed from the dispensers into totes for filling the orders. Each tote has a unique identity and information storage medium, as well as an interface for communicating with the central computer and the frame controllers. The medium may be an RFID tag, a computer chip with an interface, or a two-dimensional or stacked barcode that contains the tote identification and the required list of items.

### FIELD OF THE INVENTION

This invention generally relates to automated picking systems used in warehouses or other distribution centers, and in particular to automated dispensing systems and order fulfillment.

### BACKGROUND OF THE INVENTION

The development of Internet sales and the shipping of packages and goods in response to Internet orders has elevated the importance of operations in warehouses of those who provide the goods. Typically, goods are stored in warehouses and orders are received from buyers, whether through the Internet or other, more conventional means, such as from mail-order or telephone order intake. Goods are selected in accordance with the customer's order, and are shipped via delivery or mail service.

It is important to operate distribution centers, their associated warehouses, and the processes for picking and sorting of the ordered goods in an efficient manner. This insures that a high volume of orders can be processed through the warehouse. and that operation costs can be kept to a minimum. Product picking for consumer products is different from order processing for an industrial customer. The number of items picked for consumer orders tends to be rather small, possibly as low as one or two items per order, rather than tens or hundreds of items picked for industrial customers. The number of orders processed per hour to maintain the same return on investment is far greater for consumer sales than for industrial sales. Thus, it is important to have systems and procedures in place for processing each order very quickly.

To improve efficiencies and reduce errors over manual picking, dedicated dispensers for dispensing individual items were developed. Such a dispenser is disclosed in U.S. Pat. No. 5,271,703. This patent describes a dispenser with a plurality of magazines, each magazine stocked with different items. Items required to fill an order are dispensed from individual magazines into a dynamically assigned order space on a conveyor belt, which accumulates in the order space those items necessary to fill an order. Once all required items are dispensed into the dynamically assigned space on the conveyor belt, the belt moves the items to a second conveyor, which moves the items in a group to a packing station. There are many chances for error in using a dynamically assigned space on the conveyor belt, and this system is subject to many such errors.

U.S. Pat. No. 6,289,260 offers an improvement for automated picking, in which totes are sent through the system, gathering items from more than one order, with subsequent re-organizing of goods for shipment, which is clearly unsuitable for high-volume, high-reliability order picking. This patent also advises segregating high volume items from low volume items, which is also the focus of U.S. Pat. No. 6,377,867. In the '867 patent, a picking head is used to gather items from stacks of movable totes, the picking head possible including a gantry robot and a vacuum for picking desired items. This will clearly be a low-volume operation and not suitable for a high-speed warehouse with a high volume of orders.

U.S. Pat No. 6,505,093 also uses gantry robots with picking heads, the picking heads having end effectors, such as a vacuum pickup or rotatable fingers. This system also uses bar codes for identifying individual totes, but does not further use the conveyor identity. While this system may be used for replenishment of the stock, it will be a slow system that is simply not suitable for a high volume of orders. U.S. Pat. No. 6,971,833 describes an order picking system with movable rack steering units that move autonomously between article racks. The autonomous rack steering units can pick items and can also replenish items in the article racks. This volume-handling capability of this system will be limited by the speed and number of the rack steering units. While conveyors are mentioned, they are not central to this invention, and will clearly play a minor role, compared to the movable rack steering units.

In a similar manner, U.S. Pat. Appl. Publ. 2005/0047895 discloses autonomous transfer and transport vehicles, the vehicles communicating with the central computer by an-onboard computer and a radio-frequency/LAN network. In this system, however, the vehicles are track-guided, requiring extensive preparation of embedded track with guides, sensors, and even a slotted-guideway for the vehicles. This will be a very expensive system, with vehicles that are much more expensive than totes.

The embodiments described herein are an improvement over the automated picking systems of the prior art. These and other advantages of the invention, as well as additional inventive features, will be apparent from the description of the embodiments provided herein.

### BRIEF SUMMARY OF THE INVENTION

One embodiment is an automated order fulfillment system. The automated order fulfillment system includes a computer system having a memory and a plurality of inputs and outputs, an A-frame system comprising a plurality of frames for storing and dispensing a plurality of items, the A-frame system in communication with the computer system, at least one powered conveyor in communication with the computer system, and a plurality of totes in communication with the computer system and the frames, each tote further including a data storage capacity for storing an identity of the tote, wherein one of the totes receives information from the computer system concerning at least one desired item, and wherein the computer system and the at least one conveyor are configured for routing the tote to the frame having the at least one desired item, and wherein the frames are configured for recognizing the totes, for dispensing the at least one desired item into the tote.

Another embodiment is an automated order fulfillment system. The automated order fulfillment system includes a computer system having a memory and a plurality of inputs and outputs, a plurality of frames, each of the plurality of frames further including a controller in communication with the computer system, and further including a powered conveyor controlled by the computer system, at least one powered system conveyor in communication with the computer system, and a plurality of totes in communication with the computer system and the plurality of frames, each tote further including a data storage capacity for storing an identity of the tote and a list of items desired from the plurality of frames, and wherein the computer system and the at least one powered system conveyor configured for routing the totes to the frames, and wherein the frames are configured for recognizing the totes, for dispensing the items on the list into the totes.

Another embodiment is an automated order fulfillment system. The automated order fulfillment system includes a computer system having a memory and a plurality of inputs and outputs, a plurality of frames for holding and dispensing a plurality of items, each of the plurality of frames further including a controller in communication with the computer system, and further including a powered conveyor controlled by the computer system, at least one of the frames further including an automated dispenser in communication with the computer system or the at least one frame, wherein the automated dispenser includes an automated dispensing mechanism having a catch actuable for dispensing an item from the at least one frame, at least one powered system conveyor in communication with the computer system, and a plurality of totes in communication with the computer system and the plurality of frames, each tote further including a data storage capacity for storing an identity of the tote and a list of items desired from the plurality of frames, and wherein the computer system and the at least one powered system conveyor are configured for routing the totes to the frames, and wherein the frames are configured for recognizing the tote, for dispensing items on the list into the tote.

Another embodiment is a method for automatically dispensing items from an A-frame system. The method includes steps of: providing a plurality of frame, each frame including a conveyor and a plurality of different items, the frames in communication with a controller of the A-frame system; providing a plurality of totes, each of the plurality of totes having an identity, an information storage capacity and an interface for communicating with the controller and the frames; generating at least one list of items from items stored in the plurality of frames; storing the at least one list on the controller and on one of the totes; routing the tote to at least one of the plurality of frames; reading the identity of the tote; reading the list of items stored on the tote; dispensing at least one item on the at least one list into the tote; and updating an inventory of items stored in the frames.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic view of a warehouse or storage system with an automated order fulfillment system;

FIG. 2 is a perspective view of one portion of an A-frame picking system;

FIG. 3 is a top view of an order fulfillment control system embodiment;

FIG. 4 is a side view of a bottom dispenser useful in an A-frame picking system;

FIGS. 4a, 4b, and 4c are partial views of the embodiment of FIG. 4; and

FIG. 5 is a flow chart for a method of operating an automated picking system.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE PRESENTLY PREFERRED EMBODIMENTS

Automated picking systems are very useful in quickly filling orders, especially in situations where there is a large number of items stored, and also a high volume of orders to be filled. Using embodiments as described herein, a warehouse order fulfillment system can quickly and efficiently fill a high volume of orders in a virtually error-free procedure. In addition, by using intelligent totes that include the list of items sought, the central controller is not overloaded, but is used to check that each order is properly filled.

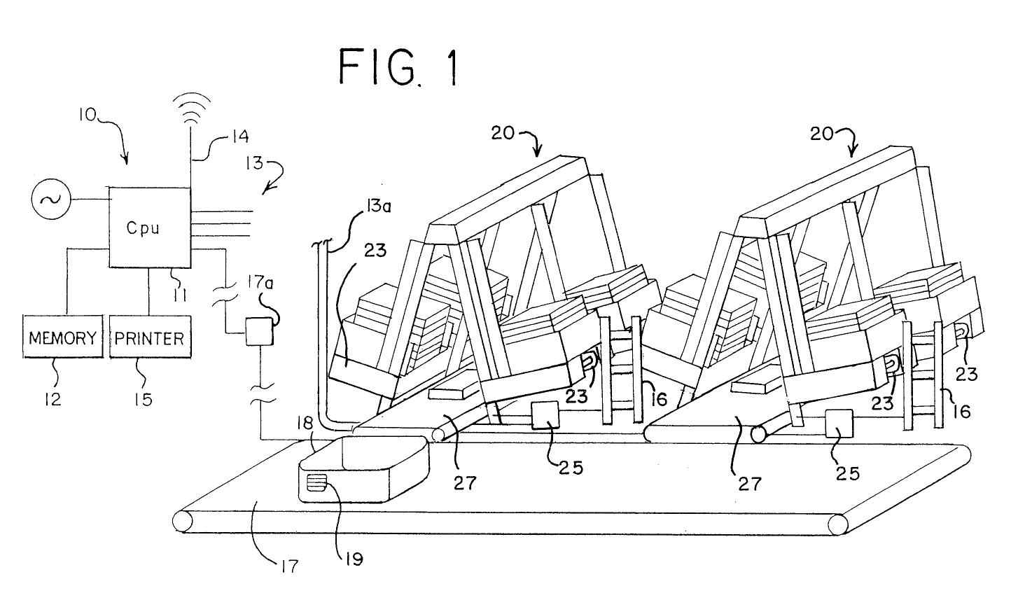

One embodiment of an automated order fulfillment system is depicted in FIG. 1. The order fulfillment 10 system, an A-frame system, includes a central computer 11 in communication with a series of frames 20, each with its own computer controller 25. Central computer 11 preferably has additional memory 12 and a plurality of input and output lines 13, which may include a radio-frequency (RF) input/output antenna 14. The system also preferably includes a printer 15. Central controller 11 may communicate with frames 20 via RF antenna 14 and local antennae 16, or the computers may also be hard-wired via land lines 13a. Order fulfillment system 10 also includes at least one power conveyor 17 for routing totes 18 through the system. Each tote 18 also has a storage medium and communications medium 19 for communicating with controller 11 and frames 20 and their controllers 25. Power conveyor 17 communicates with computer 11 via conveyor controller 17a.

When an order from a customer enters the system 10, the order is received by central computer 11. Central computer 11 checks the list against the inventory records for the system, which inventory may be maintained in the central computer or its memory 12. The central computer can then calculate whether there is a sufficient quantity in inventory for each item on the list, and can then prepare the list for downloading to a particular tote. The central computer can also prepare a temporary or intermediate count for the items on the list, noting that the particular quantities of these particular items have been committed to this particular list. By using an intermediate count, the computer will not over-commit, e.g., “double commit” the items in inventory. The central computer then selects a particular tote 18, each tote having its own identity and also its own storage medium and communications medium. The central computer identifies the chosen tote and downloads the list of items for the order into the memory of the tote. Thus, once the tote is chosen and the list is downloaded, the tote itself has the information needed to fill the order.

The storage medium and the communications medium on each tote act to uniquely identify each tote, store a list of items desired for placement into the tote, and also include the capability for communicating information to and from the central computer and the individual frame computers and controllers. One storage medium is a radio-frequency identification device (RFID). This device may or may not have a power source, e.g., a battery, since many RFID tags can store information and retrieve the information using the power from an antenna 16 that “reads” the information stored on the tag. This information includes the identification of the particular tote, as well as the items from a particular list. As the tote wends its way through the system, and as items from the list are placed into the tote, the memory may be updated so that at the end of its run through the system, a final check of the tote will confirm that all items on the list have been placed into the tote, and the items may then be sent or shipped where desired. RFID systems, including the tags, the antennae, and programming and control devices, are available from a variety of manufacturers and suppliers.

In addition to the RFID embodiment, two-dimensional or stacked bar codes may also be used. The bar codes may be encoded by the computer, printed by the system printer or an auxiliary remote printer that is near a tote storage area. The two-dimensional bar code is then placed onto the tote, which is routed to a stock storage and retrieval area. The conveyor system routes the tote to the frames, the frames containing items on the list prepared by the computer for placement onto the tote. A bar code scanner (camera capture device) on the frame reads the bar code and dispenses the appropriate quantity of each item for that tote. When the last item on the list has been placed into the tote, the tote is checked to be sure that all items on the list are present in the correct quantity. Two-dimensional bar code systems are available from a variety of manufacturers with a variety of different codes. Of course, the bar code on the tote is not altered once it is printed, but it could be re-printed. The bar code embodiment depends on the system computer and the frame computers and controllers to keep track of items in the tote.

There are many other totes useful in embodiments of the present invention. The tote may instead include a low-cost computer memory chip, and an interface for reading and writing to the chip, before, during, and after a run through the system. The chip desirably includes its own low-voltage power source, e.g., a replaceable battery. The chip is placed onto the tote and a particular list is downloaded from the system computer to the chip. The tote is routed through the storage area to the appropriate frame, which “reads” the chip and then places the appropriate quantity of items from the list into the tote. The frame may also update the chip by noting the actual quantity of each item dispensed into the tote. At the end of the list, the chip may be scanned again to determine that all items on the list are correctly placed into the tote for shipping. An example of such a chip is the iButton computer chip from Dallas Semiconductor, Dallas, Tex., U.S.A. The chip may be scanned and read/write is accomplished with 1-wire scanners or wireless scanners. Examples include a 1-wire HA2-RS232 1-wire scanner available from Maxim Integrated Products, Sunnyvale, Calif., U.S.A., for interfacing to a system computer or a frame computer via an RS232 interface. A wireless example is the HA6-900, 1-wire, 900 MHz wireless interface, available from Embedded Data Systems, Lawrenceburg, Ky., U.S.A.

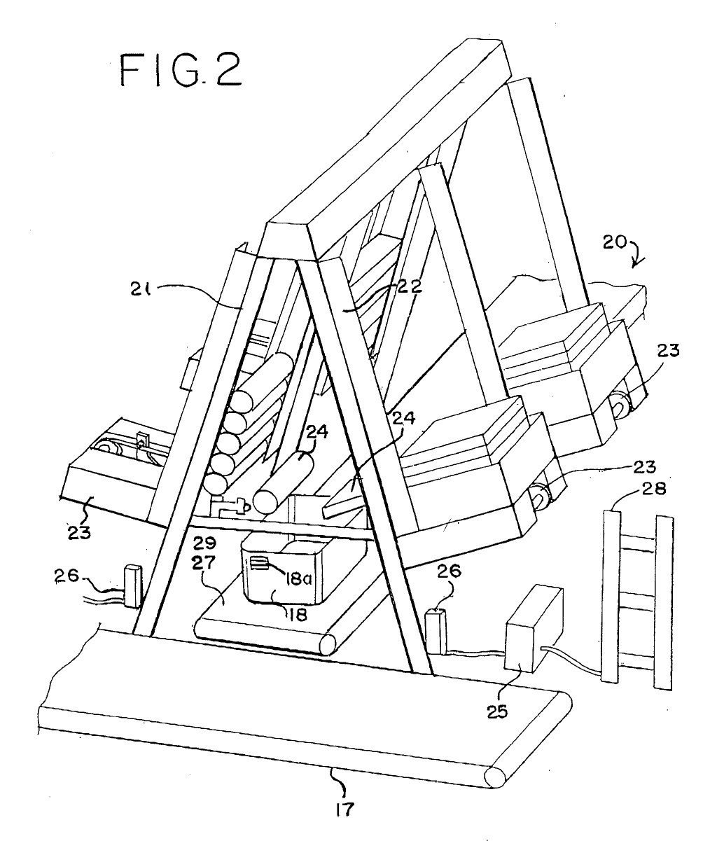

Items stored in the automated order fulfillment system are preferably stored in dispenser with stacks of items on the frames. A frame 20 useful in embodiments of the present invention is depicted in FIG. 2. Similar frames are described in U.S. Pat. No. 5,271,703, which is hereby incorporated by reference in its entirety, as though each and every page were set forth herein. Frame 20 includes two sides, 21, 22, which lean inwardly toward each other, roughly forming the letter “A.” Each side is divided into a plurality of horizontally-separated dispensers for items, the dispensers roughly vertical, at about the same angle as the frame sides. The frame has several dispensers 23 for dispensing items 24 from the horizontal positions, the dispensers to be discussed below. The frame is controlled by computer controller 25, which may be a microprocessor controller. There may also be an interface 26, preferably for each side of the frame, to terminate the wires from dispensers 23 and any other electrical devices, such as sensors or lights, used for each stack of items.

The frame has a central conveyor 27 for conveying items dispensed from the dispensers into the proper tote 18, which is routed to frame 20 via system conveyor 17. The frame preferably also has interfaces 28, 29, for exchanging information with the totes used in this system. Frame/tote interface devices may include an antenna 28 for reading and writing to RFID devices for totes so equipped, or a bar code camera capture device 29, for reading two-dimensional or stacked bar codes from totes in systems using a bar code. Alternatively, the interfaces may be suitable for wired or wireless communications with a computer chip on the tote. Tote 18 includes a device 18a for storing information, the information on the device preferably, but not necessarily, being updated by the system central computer or the frame computer controller 25, as items from the list stored on the tote are placed into the tote.

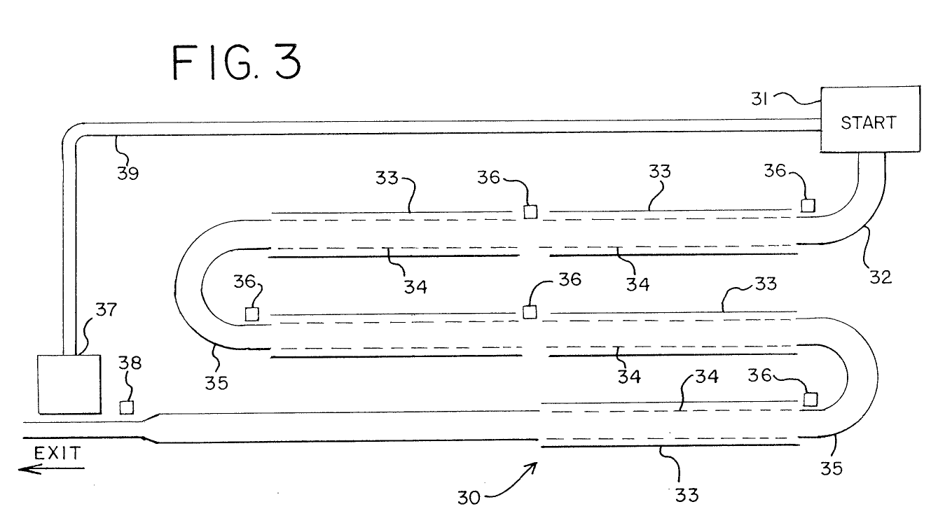

An order fulfillment system preferably includes a plurality of frames, a sophisticated control system, and a reliable conveyor system. One embodiment is disclosed in FIG. 3. Order fulfillment system 30 includes a system controller 31, which includes a computer and at least one input/output device as previously described. The controller takes the next available tote, reads the tote identification, and assigns the tote a list of items to gather, such as an order from a customer, internal or external. The controller then downloads the information to the tote, whether by printing a two-dimensional bar code, or by writing the information to an RFID tag or to a computer chip on the tote. The controller then routes the tote to the conveyor system 32. In this embodiment, there are five frames 33, each with its own internal conveyor 34 and information interface 36, which are in communication with the system controller.

As discussed previously, the information interface 36 may be a wired interface for a computer chip, such as a 1-wire interface for an iButton chip. Alternatively, the interface may be an RF antenna or a bar code reading device. In the embodiment of FIG. 3, totes may be routed automatically through all frames 33 by system controller 31, the system controller controlling conveyor system 32. Alternatively, conveyor system 32 may include by-passes around at least some of the frames, so that when an order and its tote have collected all desired items, the tote may be routed directly to the desired frame. When the information on the tote is read by the information interface 36 of the frame, the tote may be stopped for loading of items, or the conveyor may be actuated by the frame controller to go to the next frame if this frame has no items on the list needed by the particular tote.

After the last frame has been passed, the totes are routed to the order checking system 37, with an information interface 38. The checking system information interface may read the RFID tag or computer chip to verify that all items on the list are present. The order checking system may then generate a packing list for shipment with the items. If one or more items are missing, the packing list may include a note that certain items were not available, and including a message about any corrective action. The message may ask the customer to check back later, tell the customer that the item has been back ordered, or any other note or message may be sent. Inventory records may be updated, and the totes may be re-routed on return conveyor 39 for their next list. Other conveyor systems and control methodologies may also be used. For instance, a person may be stationed at the order checking system 37 to manually check at least some aspects of the order; alternatively, a person at a packing station downstream from order checking may manually check the order.

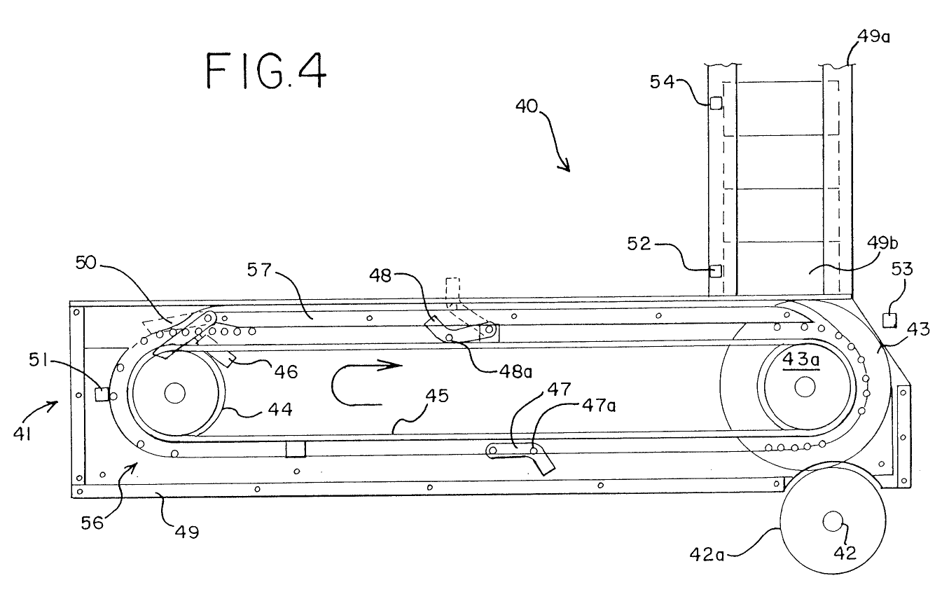

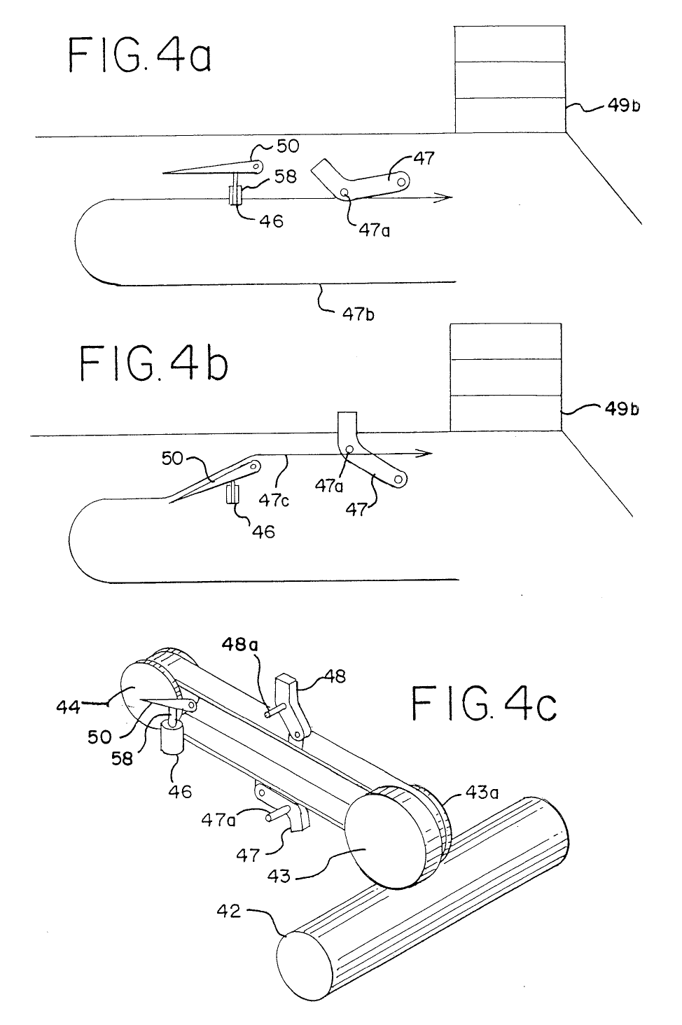

The frames themselves form an important part of embodiments of the invention. For instance, if an frame cannot timely and accurately dispense items from its dispensers onto its internal conveyor, automated picking will not work, at least for that particular frame. One weak point in previous frames and A-frame systems has been the dispensing, and in particular, the dispensing mechanisms used to drop items onto the conveyor. An improved dispenser useful in frames is depicted in FIG. 4. Dispenser 40 includes a dispensing mechanism 41, housing 49, and roughly vertical rails 49a supporting a stack of goods 49b. The frame controller drives a drive shaft 42 with optional power transmission element (pulley or gear) 42a to provide power to the dispensing mechanism 41, which may run continuously or start up on command from the frame controller. Drive shaft 42 drives a driven power transmission element 43, which may be a double element, as shown with smaller, co-axial element 43a, endless belt 45, and a guide roller 44. The dispensing mechanism is intended to pull items, one at a time, from stack 49b. In one embodiment, power transmission element 43 and co-axial element 43a are molded polyurethane drive wheels. Other embodiments, such as with gears or sprockets, may also be used.

The goods are reliably pulled from the stack in the following manner. When the tote moves to the appropriate frame, the frame controller reads the tote identification and the list of items desired. Items from the particular frame are noted by the controller. For each item on the list, the frame controller actuates the appropriate dispenser 40, dispensing mechanism 41 and a solenoid 46, which moves an escapement 50 from an upward spring-retained position, as shown in dotted line, to a downward position as shown in solid line. Spring 58 preferably normally holds escapement 50 in the upper position. Spring 58 is preferably a torsional spring or a compression spring on the under-side of escapement 50, keeping the plunger of the solenoid extended, as shown in FIGS. 4a-4c. It may also be an extension spring, for instance, if it is used on the top side of escapement 50. Actuation of the escapement 50 by solenoid 46 occurs when sensor 51 senses the next pawl 47 or 48 to arrive in position, and the control system has indicated that an item should be dispensed. When the escapement 50 is in the downward position (solid line), the guide pin 48a of pawl 48, riding in guide 56, is guided by escapement 50 to the top side of upper guide 57, where pawl 48 is extended to the upward position (dashed line). The path of guide pin 47a in the downward position is depicted as route 47b in FIG. 4a, with pawl 47 in the downward or non-dispensing position. The path of guide pin 47a is shown shifted upward to path 49c in FIG. 4b, with pawl 47 now moved to the upward or dispensing position. Guides 56 and 57, best seen in FIG. 4, may be strips of metal or other material secured to the inside of frame 41, such as by welding, bolting, or other securing method.

If the escapement 50 has guided the appropriate guide pin 47a, 48a to upper guide 57, the pawl is then shifted to an upright position for dispensing an item because the guide pin 47a or 48a holds the pawl in the upright position. In this position, the pawl contacts the bottom item 49b of the stack and pushes it out of the dispenser 40 into a tote. As an item 49b is dispensed, sensor 53 validates that item 49b actually exited dispenser 40. Sensor 51 and sensor 53 may be any suitable sensors, such as proximity sensors, motion-detection sensors, optical sensors, or other type of sensors. After pawl 48 has dispensed the item, and is no longer held upright by upper guide 57, pawl 48 follows the path of guide 56 on which guide pin 48a runs.

The speed of the dispenser is preferably fixed, and the frame controller can retract escapement 50 to the upward position based on a fixed time interval. If the speed of the dispenser is variable, the controller can retract escapement 50 based on an appropriate time interval, so that only the desired number of items is dispensed. By operating the dispenser in this manner, the next pawl 47, 48 to arrive remains in the lower position, as indicated by the solid line depiction of pawl 48, and does not dispense another product unless the escapement 50 is again actuated to the lower position. Sensor 52 is utilized to determine whether the dispenser is empty, and sensor 54 is preferably used to indicate a “low-stock” level in the dispenser, so that re-stocking may be performed an empty condition is reached. Sensor 52 and sensor 54 may be any suitable sensors, either may be a proximity sensor, a motion-detection sensor, an optical sensor, or other type of sensor.

The systems described above may be operated with powered conveyors as shown. There are others way to move the totes through the system, however, such as a “pusher” mechanism or a walking beam mechanism. In a pusher mechanism, all the totes or a number of totes may be aligned in contact in end-to-end fashion and then pushed through the frames of the system using a simple air-cylinder or other pusher. Such a pusher typically includes a housing, an air cylinder, and a pusher bar. When the air cylinder is activated, a pusher bar pushes a tote atop rollers to move the tote through the frames. The air cylinder may have a stroke equal to the length of the tote, so that when a tote is added to the system and the air cylinder is actuated, each tote in contact with the new tote is pushed one tote length, i.e., one air cylinder stroke.

In another embodiment, a walking beam tote feed mechanism is used. One embodiment of such a walking beam is described in U.S. Pat. No. 4,424,082, which is hereby incorporated in its entirety. In this embodiment, an air cylinder is also actuated to index one or more pivoting arms that push one or more totes along their desired path. When the air cylinder is actuated and extended, the arm or arms push the tote or totes along the desired path. When the air cylinder is retracted, the arm pivots on a spring so that retraction does not move the totes in the opposite direction. There may also be an escapement mechanism on the roller conveyor that prevents rearward movement of at least the end tote. In this way, the walking beam may move one or more totes, but when one tote is moved, all the totes move and index along the path. There are many other ways to practice this invention.

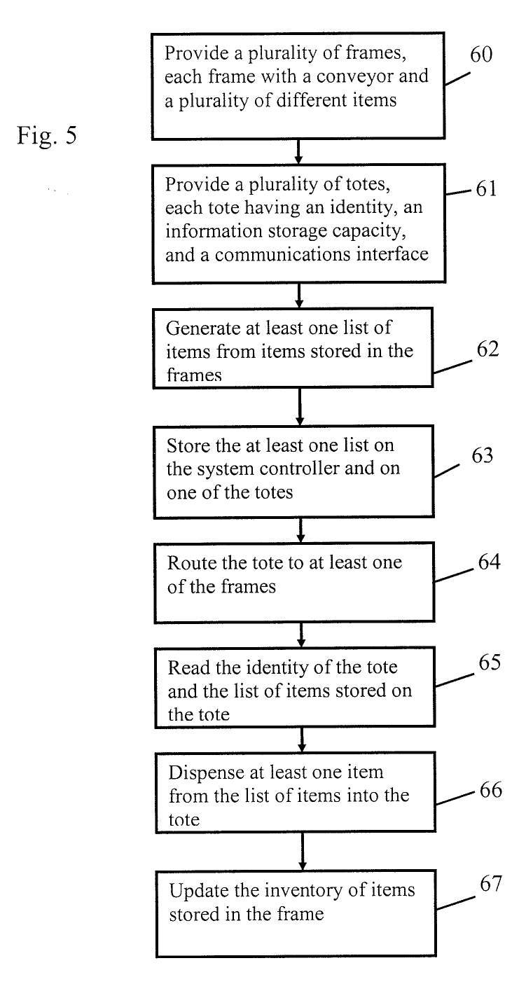

The order fulfillment system may be operated in many ways. One method for operating the system is depicted in the flowchart of FIG. 5. In this method, a plurality of frames is provided 60. The frame as a whole dispenses items from stock, but each frame may also have one or more on-board dispensers, i.e., one or more mechanical devices that store and dispenses items from their storage places on the frame. Each frame, preferably about 24 inches long, has an internal conveyor and is stocked with a plurality of items, preferably a plurality of each item, rather than merely one of each stock keeping unit (SKU). The method also includes providing 61 a plurality of totes, each tote having an identity, an information storage capacity, and a communications interface. In some units, the communications interface may be the information itself, e.g., a printed, two-dimensional bar code. The method includes generating 62 at least one list of items from among items stored in the frames.

Other steps of the method include storing 63 the list on the system controller and on one of the totes. The tote is then routed 64 to at least one of the frames that contains an item on the list. The frame then reads 65 the identity of the tote and also reads the list of items stored on the tote. The frame then dispenses 66 at least one item from the list of items into the tote. The inventory of items stored on the frame is then updated 67. The tote is then routed, preferably in an efficient manner, to each frame that stores an item on the list and this process is repeated.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An automated order fulfillment system, comprising:
a computer system having a memory and a plurality of inputs and outputs;
an A-frame system comprising a plurality of frames for storing and dispensing a plurality of items, the A-frame system in communication with the computer system;
at least one powered conveyor in communication with the computer system; and
a plurality of totes in communication with the computer system and the frames, each tote further comprising a data storage capacity for storing an identity of the tote, wherein one of the totes receives information from the computer system concerning at least one desired item, and wherein the computer system and the at least one conveyor are configured for routing the tote to the frame having the at least one desired item, and wherein the frames are configured for recognizing the totes, for dispensing the at least one desired item into the tote.

2. The automated system according to claim 1, further comprising a radio-frequency tag mounted on each of the plurality of totes, and further comprising a radio-frequency antenna in communication with each of the frames.

3. The automated system according to claim 1, further comprising a two-dimensional bar code attached to each of the plurality of totes, and further comprising a barcode scanner in communication with each of the frames.

4. The automated system according to claim 1, further comprising a computer chip and an interface attached to each of the plurality of totes, and further comprising a chip reader in communication with each of the frames.

5. The automated system according to claim 1, wherein each of the frames comprises a plurality of items, each of the plurality of items stored for one-at-a-time dispensing.

6. The automated system according to claim 1, wherein each of the frames comprises a powered conveyor.

7. The automated system according to claim 1, wherein at least one item is stored in at least two different locations in the A-frame system.

8. The automated system according to claim 1, further comprising at least one dispenser having an automated dispensing mechanism on at least one frame, the at least one dispenser in communication with the computer system or the at least one frame, wherein the automated dispensing mechanism comprises a pawl actuable for dispensing the desired item from the at least one frame.

9. The automated system according to claim 1, further comprising at least two automated dispensers on at least one frame, the at least two automated dispensers in communication with the computer system or the at least one A-frame, wherein the automated dispensers are driven by a single motor controlled by the at least one frame and wherein each of the automated dispensers comprises an automated dispensing mechanism having a pawl for dispensing the desired item from the at least one frame.

10. The automated system according to claim 1, further comprising at least one dispenser on a frame of the system, the at least one dispenser in communication with the computer system or the at least one frame, wherein the dispenser comprises an automatic dispensing mechanism with a pawl actuable for dispensing the desired item, and further comprising at least one sensor for detecting a presence of the pawl, a presence of the at least one item, or movement of the at least one item from the dispenser.

11. An automated order fulfillment system, comprising:
a computer system having a memory and a plurality of inputs and outputs;
a plurality of frames, each of the plurality of frames further comprising a controller in communication with the computer system, and further comprising a powered conveyor controlled by the computer
at least one powered system conveyor in communication with the computer system; and
a plurality of totes in communication with the computer system and the plurality of frames, each tote further comprising a data storage capacity for storing an identity of the tote and a list of items desired from the plurality of frames, and wherein the computer system and the at least one powered system conveyor are configured for routing the totes to the frames, and wherein the frames are configured for recognizing the totes for dispensing the items on the list into the totes.

12. The automated system according to claim 11, further comprising a radio-frequency tag mounted on each of the plurality of totes, and further comprising a radio-frequency antenna in communication with each of the frames.

13. The automated system according to claim 11, further comprising a two-dimensional bar code attached to each of the plurality of totes, and further comprising a barcode scanner in communication with each of the frames.

14. The automated system according to claim 11, further comprising a computer chip and an interface attached to each of the plurality of totes, and further comprising a chip reader in communication with each of the frames.

15. The automated system according to claim 11, wherein each of the frames comprises a plurality of items, each of the plurality of items stored for one-at-a-time dispensing.

16. An automated order fulfillment system, comprising:
a computer system having a memory and a plurality of inputs and outputs;
a plurality of frames for holding and dispensing a plurality of items, each of the plurality of frames further comprising a controller in communication with the computer system, and further comprising a powered conveyor controlled by the computer system, at least one of the frames further comprising an automated dispenser in communication with the computer system or the at least one frame, wherein the automated dispenser comprises an automated dispensing mechanism having a catch actuable for dispensing an item from the at least one frame;
at least one powered system conveyor in communication with the computer system; and
a plurality of totes in communication with the computer system and the plurality of frames, each tote further comprising a data storage capacity for storing an identity of the tote and a list of items desired from the plurality of frames, and wherein the computer system and the at least one powered system conveyor are configured for routing the totes to the frames, and wherein the frames are configured for recognizing the totes, for dispensing items on the list into the totes.

17. The automated order fulfillment system of claim 16, wherein at least one item is stored in at least two locations among the plurality of frames.

18. A method for automatically dispensing items from an A-frame system, the method comprising:
providing a plurality of frames, each frame comprising a conveyor and a plurality of different items, the frames in communication with a controller of the A-frame system;
providing a plurality of totes, each of the plurality of totes having an identity, an information storage capacity and an interface for communicating with the controller and the frames;
generating at least one list of items from items stored in the plurality of frames;
storing the at least one list on the controller and on one of the totes;
routing the tote to at least one of the plurality of frames;
reading the identity of the tote;
reading the list of items stored on the tote;
dispensing at least one item on the at least one list into the tote; and
updating an inventory of items stored in the frames.

19. The method of claim 18, wherein the steps of reading the identity and reading the list of items is accomplished by a method selected from the group consisting of: reading a two-dimensional bar code on the tote; reading the RFID tag on the tote; and scanning a computer chip on the tote.

20. The method of claim 18, further comprising dispensing an item from one of the plurality of frames by actuating a catch on at least one dispenser to push an item onto a conveyor or into the tote.

21. The method of claim 18, wherein the step of routing the tote to at least one of the plurality of frames comprises routing the tote to a zone in at least one of the plurality of frames.
